(19) United States
(12) Patent Application Publication
(10) Pub. No.: US 2023/0142200 A1
(43) Pub. Date: May 11, 2023

(54) NON-TRANSITORY STORAGE MEDIUM, PROCESSING METHOD FOR PORTABLE TERMINAL, AND PORTABLE TERMINAL

(71) Applicant: NEC Corporation, Minato-ku, Tokyo (JP)

(72) Inventors: Yasunari TSUJI, Tokyo (JP); Yoshiko Imanishi, Tokyo (JP)

(73) Assignee: NEC Corporation, Minato-ku, Tokyo (JP)

(21) Appl. No.: 17/795,286

(22) PCT Filed: Jan. 18, 2021
(86) PCT No.: PCT/JP2021/001485

§ 371 Date: Jul. 26, 2022

(30) Foreign Application Priority Data
Feb. 10, 2020 (JP) 2020-020379

(51) Int. Cl. G06F 3/01; G06F 3/04886; G06V 40/10; G06V 40/60

(52) U.S. Cl. CPC G06F 3/011; G06F 3/04886; G06V 40/11; G06V 40/67; G06V 40/166

(57) ABSTRACT

The present invention provides a portable terminal (10) that includes an acquisition unit (11) that acquires a user image including a user, and a screen generation unit (12) that changes a position of an operation button on a screen to be displayed on a touch panel display (14), according to whether a hand of the user included in the user image is a right hand or a left hand.

### TECHNICAL FIELD

The present invention relates to a program, a processing method for a portable terminal, and the portable terminal.

### BACKGROUND ART

Patent Document 1 discloses an authentication apparatus that performs authentication based on an image.

Patent Document 2 discloses a portable terminal that recognizes, based on a detection result of an acceleration sensor, whether a user's operation pattern is left hand input with left hand holding, right hand input with right hand holding, right hand input with left hand holding, left hand input with right hand holding, or both hands input with both hands holding, and changes, based on a result thereof, a position and the like of an operation button displayed on a touch panel display.

### RELATED DOCUMENT

### Patent Document

[Patent Document 1] Japanese Patent Application Publication No. 2017-142859

[Patent Document 2] Japanese Patent Application Publication No. 2012-191445

### DISCLOSURE OF THE INVENTION

### Technical Problem

As in the technique disclosed in Patent Document 2, operability for a user is improved by determining a hand with which the user holds a portable terminal, and changing, based on a result of the determination, a position and the like of an operation button displayed on a display. However, the technique disclosed in Patent Document 2 of determining, based on a detection result of an acceleration sensor, a hand with which a user holds a portable terminal has a problem of not being able to determine with sufficient accuracy. When left hand holding is incorrectly determined as right hand holding and the operation button is displayed at a position for right hand holding, operability becomes very poor.

An object of the present invention is to determine with high accuracy a hand with which a user holds a portable terminal and to provide a screen with good operability suitable for a holding state thereof.

### Solution to Problem

According to the present invention,

a program used in a portable terminal, causing the portable terminal to function as:

an acquisition means for acquiring a user image including a user; and

a screen generation means for changing a position of an operation button on a screen to be displayed on a touch panel display, according to whether a hand of the user included in the user image is a right hand or a left hand

is provided.

Further, according to the present invention,

a processing method for a portable terminal, including:

acquiring a user image including a user; and

changing a position of an operation button on a screen to be displayed on a touch panel display, according to whether a hand of the user included in the user image is a right hand or a left hand

is provided.

Further, according to the present invention,

a portable terminal including:

an acquisition unit that acquires a user image including a user; and

a screen generation unit that changes a position of an operation button on a screen to be displayed on a touch panel display, according to whether a hand of the user included in the user image is a right hand or a left hand

is provided.

Further, according to the present invention,

a server including:

an acquisition means for acquiring, from a portable terminal, a user image including a user;

a screen generation means for changing a position of an operation button on a screen to be displayed on a touch panel display of the portable terminal, according to whether a hand of the user included in the user image is a right hand or a left hand; and

a transmission means for transmitting the screen to the portable terminal

is provided.

### Advantageous Effects of Invention

According to the present invention, a hand with which a user holds a portable terminal can be determined with high accuracy and a screen with good operability suitable for a holding state thereof can be provided.

### BRIEF DESCRIPTION OF THE DRAWINGS

FIG. 1 is a diagram for describing a function of a portable terminal according to the present example embodiment.

FIG. 2 is a diagram illustrating one example of a hardware configuration of the portable terminal according to the present example embodiment.

FIG. 3 is one example of a functional block diagram of the portable terminal according to the present example embodiment.

FIG. 4 is a flowchart illustrating one example of a processing flow of the portable terminal according to the present example embodiment.

FIG. 5 is a diagram for describing a function of the portable terminal according to the present example embodiment.

FIG. 6 is one example of a functional block diagram of the portable terminal according to the present example embodiment.

FIG. 7 is a flowchart illustrating one example of a processing flow of the portable terminal according to the present example embodiment.

FIG. 8 is one example of a functional block diagram of the portable terminal and a server according to the present example embodiment.

### DESCRIPTION OF EMBODIMENTS

### First Example Embodiment

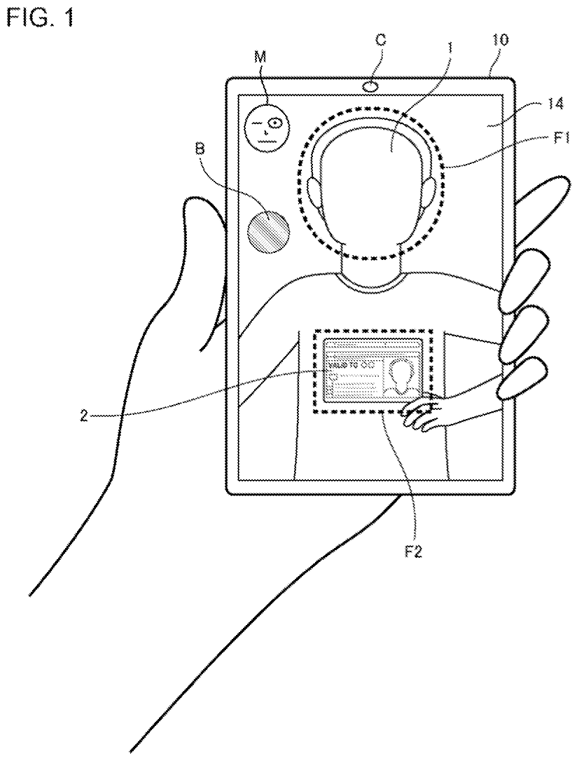

First, an outline of a portable terminal according to the present example embodiment is described. As a premise, the portable terminal includes a camera function and a touch panel display, and is configured in such a way as to be able to perform so-called “self-photographing”. As illustrated in FIG. 1, a portable terminal 10 includes a camera lens C on the same surface as a touch panel display 14. Further, in self-photographing, a user image including a user, which is generated by collecting light by using the camera lens C, is displayed on the touch panel display 14. The user operates the touch panel display 14 and performs photographing while checking the user image including himself/herself displayed on the touch panel display 14.

Further, by determining a hand of to user included in the user image generated in self-photographing, the portable terminal 10 determines with high accuracy a hand with which the user holds the portable terminal 10. The portable terminal 10 determines a hand not being included in an image as a hand holding the portable terminal 10. Further, the portable terminal 10 generates a screen with good operability suitable for a determined holding state, and displays the screen on the touch panel display 14.

In the following, a configuration of the portable terminal 10 is described in detail. First, one example of a hardware configuration of the portable terminal 10 is described. The portable terminal 10 is a smart phone, a tablet terminal, a mobile phone, a portable game console, or the like, but is not limited thereto.

A functional unit included in the portable terminal 10 according to the present example embodiment is achieved by any combination of a software and a hardware, mainly including a central processing unit (CPU) of any computer, a memory, a program loaded into a memory, a storage unit, such as a hard disk, storing the program (in addition to a program stored in advance from a stage of shipping an apparatus, a program downloaded from a storage medium such as a compact disc (CD) or from a server on the Internet can also be stored), and an interface for network connection. Further, it is understood by a person skilled in the art that there are various modification examples of a method and an apparatus for achieving the portable terminal 10.

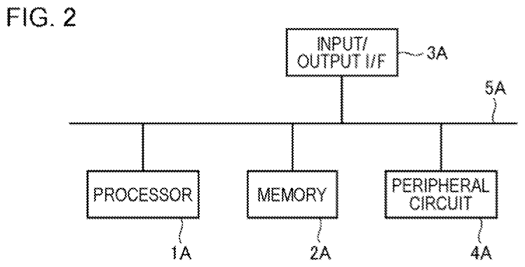

FIG. 2 is a block diagram illustrating a hardware configuration of the portable terminal 10 according to the present example embodiment. As illustrated in FIG. 2, the portable terminal 10 includes a processor 1A, a memory 2A, an input/output interface 3A, a peripheral circuit 4A, and a bus 5A. The peripheral circuit 4A includes various modules. The portable terminal 10 may not include the peripheral circuit 4A. Note that, the portable terminal 10 may be configured of a single apparatus that is physically and/or logically integrated, or may be configured of a plurality of apparatuses that are physically and/or logically separated. When the portable terminal 10 is configured of the plurality of apparatuses that are physically and/or logically separated, each of the plurality of apparatuses may include the above-described hardware configuration.

The bus 5A is a data transmission path for the processor 1A, the memory 2A, the peripheral circuit 4A, and input/output interface 3A to transmit/receive data to/from one another. The processor 1A is an arithmetic processing apparatus such as a CPU or a graphics processing unit (GPU), for example. The memory 2A is a memory such as a random access memory (RAM) or a read only memory (ROM), for example. The input/output interface 3A includes an interface for acquiring information from an input apparatus, an external apparatus, an external server, an external sensor, a camera, and the like, an interface for outputting information to an output apparatus, an external apparatus, an external server, and the like, and the like. The input apparatus is, for example, a keyboard, a mouse, a microphone, a touch panel, a physical button, a camera, and the like. The output apparatus is, for example, a display, a speaker, a printer, a mailer, and the like. The processor 1A can issue a command to each module and perform an arithmetic operation, based on a result of the arithmetic operation of the module.

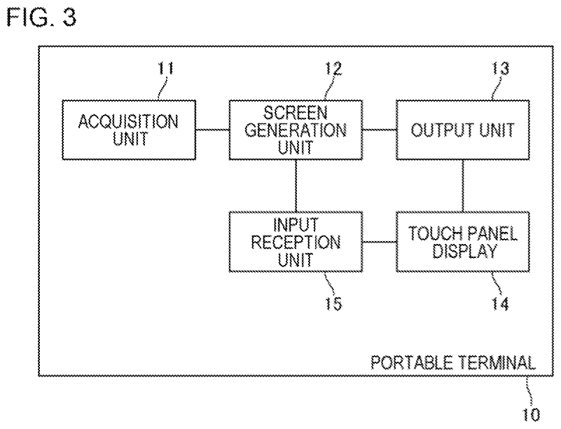

Next, a functional configuration of the portable terminal 10 is described. FIG. 3 illustrates one example of a functional block diagram of the portable terminal 10. As illustrated, the portable terminal 10 includes an acquisition unit 11, a screen generation unit 12, an output unit 13, a touch panel display 14, and an input reception unit 15. The acquisition unit 11, the screen generation unit 12, the output unit 13, and the input reception unit 15 are achieved by installing a predetermined application on the portable terminal 10.

The predetermined application is an application being provided by a business entity providing a predetermined service. The predetermined service provided by a business entity includes opening of a financial institute account, application for a credit card, a payment service using codes and the like, and the like, but is not limited thereto. The predetermined application executes personal identification processing before starting to provide these services. In the personal identification processing, a user image including a face 1 of a user receiving the service and a personal identification document 2 is generated as illustrated in FIG. 1, and personal identification is performed by collating the face 1 with a face of the user included in the personal identification document 2.

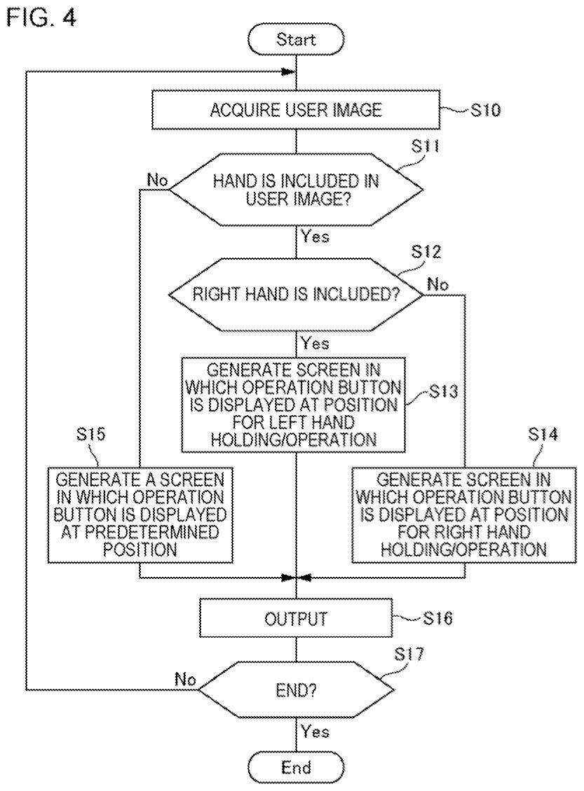

When executing the personal identification processing, the portable terminal 10 generates a screen in which an operation button B is superimposed on the user image and displays the screen on the touch panel display 14. Further, the portable terminal 10 determines with high accuracy, based on the user image, a hand with which the user holds the portable terminal 10, generates a screen with good operability suitable for a holding state thereof, and displays the screen on the touch panel display 14. By using a flowchart in FIG. 4, configuration of each functional unit is described along with a processing flow of providing the screen.

First, when the personal identification processing is started after the predetermined application is activated in response to a user operation and the like, a camera function of the portable terminal 10 is turned on. Then, the portable terminal 10 collects light by using the camera lens C on the same surface as the touch panel display 14, and generates a user image including a user.

Then, the acquisition unit 11 acquires the user image generated by the camera function of the portable terminal 10 (S10).

Next, the screen generation unit 12 analyzes the user image, and judges whether a hand of a user is included in the user image (S11) and whether a hand of a user included in the user image is a right hand or a left hand (S12). For example, the screen generation unit 12 may perform the above-described judgement, based on an estimation model generated with machine learning based on training data in which an image of a hand of a user is associated with a label indicating whether the hand in the image is a right hand or a left hand. According to the estimation model, an estimation result that “the hand of the user is not included”, “the right hand is included”, or “the left hand is included” is acquired.

As another method of judgement, for example, the screen generation unit 12 may determine a hand holding the personal identification document 2, and judge whether the holding hand is a right hand or a left hand, based on whether the determined hand is holding a right side of the personal identification document 2 (for example, a right half of the personal identification document 2 vertically equally divided into two parts) or a left side of the personal identification document 2 (for example, a left half of the personal identification document 2 vertically equally divided into two parts). For example, the screen generation unit 12 may determine a hand in contact with the personal identification document 2 as a hand holding the personal identification document 2. Further, when the right side of the personal identification document 2 as viewed from a user is held, the screen generation unit 12 may judge that the hand holding the personal identification document 2 is the right hand, and when the left side of the personal identification document 2 as viewed from a user is held, the screen generation unit 12 may judge that the hand holding the personal identification document 2 is the left hand.

After that, as illustrated in FIG. 1, the screen generation unit 12 generates a screen in which the operation button B, a frame F1 guiding a position of a face, and a frame F2 guiding a position of the personal identification document 2 are superimposed on the user image (S13 to S15). Then, the output unit 13 causes the touch panel display 14 to display the screen (S16). The personal identification document 2 is an identification card including a face image of a user and is exemplified by a driver's license, a passport, and the like, but is not limited thereto.

Note that, the screen generation unit 12 generates screens with different positions of the operation button B on the screen, according to whether a hand of a user is included in the user image (a result of the judgement in S11). Further, the screen generation unit 12 generates screens with different positions of the operation button B, according to whether a hand included in the user image is a right hand or a left hand (a result of the judgement in S12). The following is a detailed description.

When a hand is included in the user image (Yes in S11) and the hand is a right hand (Yes in S12), the screen generation unit 12 generates a screen in which the operation button B is displayed at a position for left hand holding/operation (S13). In personal identification processing that requires photographing of the personal identification document 2, a hand holding the personal identification document 2 is included in the user image, as illustrated in FIG. 1.

For example, as illustrated in FIG. 1, when a right hand is included in the user image, the screen generation unit 12 moves the position of the operation button B leftward as viewed from a user, compared to when a left hand is included in the user image. Further, for example, when a right hand is included in the user image, the screen generation unit 12 displays the operation button B in a left side area as viewed from a user, which is one of two areas that vertically equally dividing the screen into two parts.

Note that, in FIG. 1, the touch panel display 14 indicates a scene in which a user holds the portable terminal 10 with a left hand and holds the personal identification document 2 with the left hand, but this is because a mirror image of the user image, which is the user image flipped horizontally, is displayed on the touch panel display 14, and the user actually holds the personal identification document 2 with a right hand. By performing the judgement in S12 on the basis of the user image before horizontal flipping, it is possible to correctly estimate which of the right or left hand is included in the user image.

Meanwhile, when a hand is included in the user image (Yes in S11) and the hand is a left hand (No in S12), the screen generation unit 12 generates a screen in which the operation button B is displayed at a position for right hand holding/operation (S14).

For example, when the left hand is included in the user image, the screen generation unit 12 moves the position of the operation button B rightward as viewed from a user, compared to when a right hand is included in the user image. Further, for example, when the left hand is included in the user image, the screen generation unit 12 displays the operation button B in a right side area as viewed from a user, which is one of two areas vertically equally dividing the screen into two parts.

Note that, when neither hand is included in the user image (No in S11), the screen generation unit 12 generates a screen in which the operation button B is displayed at a predetermined position being determined in advance (S15). For example, the screen generation unit 12 may display the operation button B at a position where distances from both left and right ends of the screen are the same (at a horizontal center of the screen).

The input reception unit 15 receives an input via the touch panel display 14. For example, the input reception unit 15 receives an operation of touching the operation button B. The operation button B may be an operation button for skipping a predetermined operation, an operation button for executing saving of a still image, an operation button for executing starting and ending of photographing a moving image, or an operation button for executing another processing.

The portable terminal 10 executes the above-described processing while executing the personal identification processing, and displays a screen with good operability on the touch panel display 14. Note that, while executing the personal identification processing, the portable terminal 10 performs main processing described below, along with the above-described processing.

In the main processing, the portable terminal 10 extracts, from the user image, the face 1 of a user and the personal identification document 2. The portable terminal 10 is capable of extracting the face 1 and of a user the personal identification document 2 from the user image, based on a feature value of appearance of the face 1 of the user and a feature value of appearance of the personal identification document 2. Next, the portable terminal 10 extracts a face of a user from the personal identification document 2. Then, the portable terminal 10 collates the face 1 of a user extracted from the user image with the face of a user extracted from the personal identification document 2, and thereby performs personal identification.

Further, the portable terminal 10 may perform biometric detection in the main processing. The portable terminal 10 can perform the biometric detection by using any technique. For example, as illustrated in FIG. 1, a mark M guiding a facial movement may be displayed, and the facial movement such as closing a right eye, closing a left eye, opening a mouth, or the like may be guided with the mark M. Further, the portable terminal 10 may perform the biometric detection by analyzing the user image and thereby detecting a facial movement as guided. In this case, the operation button B may be an operation button for skipping a facial movement being currently requested.

Note that, since personal identification and biometric detection are widely known techniques, detailed descriptions thereof are omitted herein.

According to the above-described portable terminal 10 according to the present example embodiment, it is possible to determine a hand with which a user holds the portable terminal and change a display position of the operation button B, based on a result of the determination. Further, according to the portable terminal 10 that is held by a user, based on a hand included in a user image, and determines a hand, the user can hold the portable terminal 10 with high accuracy and determine the hand. As a result, it is possible to reduce occurrence of an inconvenience of displaying the operation button B at a position for right hand holding because of incorrectly determining as right hand holding at a time of left hand holding, or displaying the operation button B at a position for left hand holding because of incorrectly determining as left hand holding at a time of right hand holding.

Further, the portable terminal 10 is capable of changing a display position of the operation button B, based on whether a hand of a user is included in the user image. Specifically, when a hand of a user is included in the user image and a hand holding the portable terminal 10 can be determined, it is possible to display the operation button B at a position suitable for each determination result, as described above. Further, when a hand of a user is not included in the user image and a hand holding the portable terminal 10 cannot be determined, it is possible to display the operation button B at a position suitable for that situation. For example, when the operation button B is displayed at the position for right hand holding at a time of left hand holding or the operation button B is displayed at the position for left hand holding at a time of right hand holding, operability becomes extremely poor. Thus, when a hand holding the portable terminal 10 cannot be determined, the portable terminal 10 displays the operation button B in, for example, the horizontal center of the screen, and thereby can reduce inconvenience of extremely poor operability, no matter which hand the portable terminal 10 is held with.

### Second Example Embodiment

A screen generation unit 12 according to the present example embodiment is capable of judging whether a hand is included in a user image and whether the included hand is a right hand or a left hand, based on a part of the user image, specifically, a partial image that includes a part on which a frame F2 guiding a position of a personal identification document 2 is superimposed. In other words, when estimation is performed using the above-described estimation model, the screen generation unit 12 inputs the above-described part of the user image into the estimation model and judges whether a hand is included in the user image and whether the included hand is a right hand or a left hand.

Other configurations of a portable terminal 10 are similar to those in the first example embodiment.

According to the portable terminal 10 according to the present example embodiment, an advantageous effect similar to that of the first example embodiment is achieved.

Further, according to the portable terminal 10 according to the present example embodiment, whether a hand is included in the user image and whether the included hand is a right hand or a left hand are judged based on a part of the user image, and therefore an amount of image data to be processed is reduced and a processing load on a computer is reduced.

Further, since the portable terminal 10 according to the present example embodiment processes the partial image that includes a part on which the frame F2 guiding the position of the personal identification document 2 is superimposed, it is highly likely that a hand of a user (a hand holding the personal identification document 2) being desired to be detected is included in the part to be processed. Therefore, even when judgement as to whether a hand is included in the user image and whether the included hand is the right hand or the left hand is made based on a part of the user image, it is possible to make the judgement with high accuracy. In other words, according to the portable terminal 10 according to the present example embodiment, a processing load on a computer is reduced while maintaining highly accurate judgement.

### Third Example Embodiment

A screen generation unit 12 according to the present example embodiment is capable of changing a position of an operation button B on a screen, according to a size of a touch panel display 14.

For example, when the size of the touch panel display 14 is equal to or larger than a reference value, the screen generation unit 12 may display the operation button B at a position lower than a vertical center of the screen. Further, when the size of the touch panel display 14 is smaller than the reference value, the screen generation unit 12 may display the operation button B at a position upper than the vertical center of the screen.

Further, the larger the size of the touch panel display 14, the more the screen generation unit 12 may move the position of the operation button B to a lower side of the screen, and the smaller the size of the touch panel display 14, the more the screen generation unit 12 may move the position of the operation button B to an upper side of the screen.

Information indicating the size of the touch panel display 14 is registered in advance in a portable terminal 10, and the screen generation unit 12 can determine the size of the touch panel display 14, based on the information. The size of the touch panel display 14 may be indicated by the number of pixels, may be indicated by a length (e.g., inches) of a diagonal line of the touch panel display 14, or may be indicated by other method.

Other configurations of the portable terminal 10 are similar to those in the first and second example embodiments.

According to the portable terminal 10 according to the present example embodiment, an advantageous effect similar to that of the first and second example embodiments is achieved.

Further, according to the portable terminal 10 according to the present example embodiment, it is possible to display the operation button B at a suitable position according to the size of the touch panel display 14. Way of holding the portable terminal 10 may vary according to the size of the touch panel display 14. Operability is improved by displaying the operation button B at a position suitable for each way of holding.

### Fourth Example Embodiment

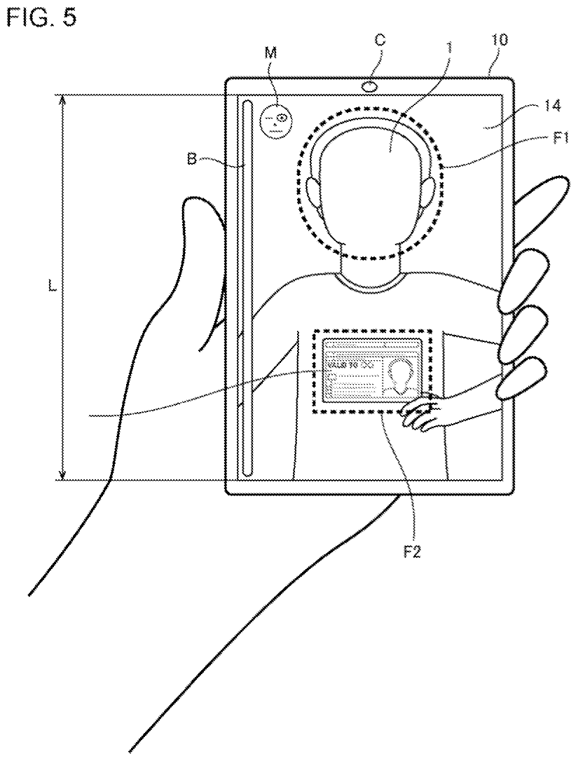

As illustrated in FIG. 5, when a vertical length of a screen displayed on a touch panel display 14 is assumed to be L, a screen generation unit 12 according to the present example embodiment displays, on the screen, an operation button B having a length of L/2 or more, more preferably having a length of 2L/3 or more, or furthermore preferably having a length of L. The operation button B is preferably positioned in such a way that an extended direction, which has a length of L/2 or more, is in parallel with a vertical direction of the screen, as illustrated in FIG. 5.

Other configurations of a portable terminal 10 are similar to those in the first to third example embodiments.

According to a portable terminal 10 according to the present example embodiment, an advantageous effect similar to that of the first to third example embodiments is achieved.

Further, according to the portable terminal 10 according to the present example embodiment, it is possible to make a length of the operation button B longer and display the operation button B being longer than a predetermined proportion of a vertical length of the touch panel display 14. Therefore, it is possible to easily operate the operation button B with a hand holding the portable terminal 10, no matter at which position of the portable terminal 10 in a vertical direction is held.

### Fifth Example Embodiment

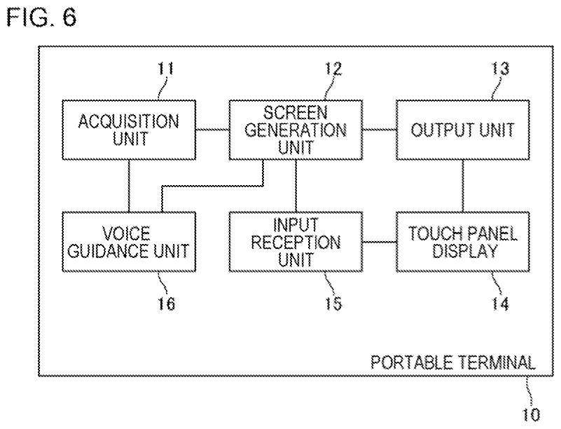

FIG. 6 illustrates one example of a functional diagram of a portable terminal 10 according to the present example embodiment. As illustrated, the portable terminal 10 includes an acquisition unit 11, a screen generation unit 12, an output unit 13, a touch panel display 14, an input reception unit 15, and a voice guidance unit 16.

The voice guidance unit 16 outputs voice guidance that eliminates misalignments of positions of a face 1 of a user and a personal identification document 2 that are detected from a user image and positions of frames F1 and F2 superimposed on the user image and displayed on the touch panel display 14. The voice guidance unit 16 outputs the voice guidance via a microphone included in the portable terminal 10.

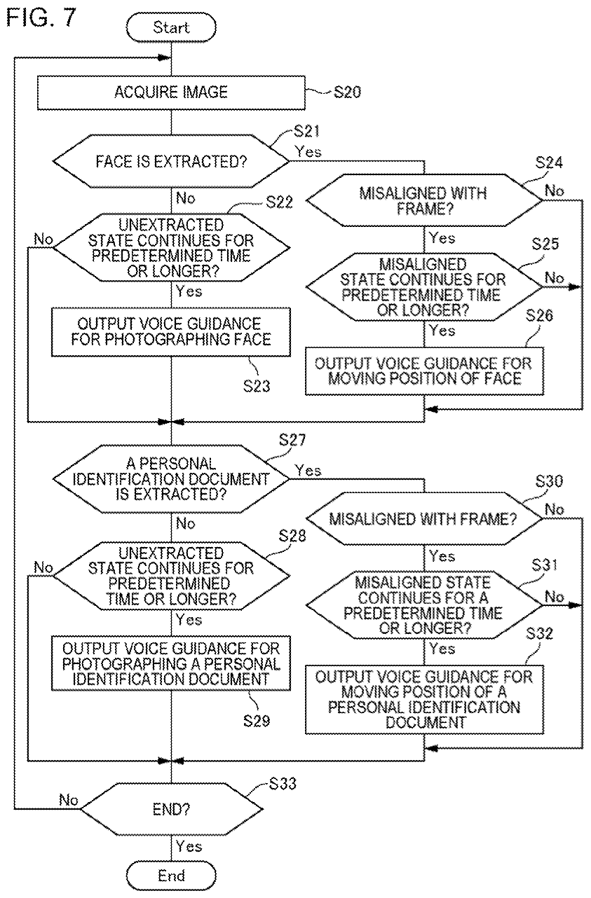

One example of a flow of voice guidance processing performed by the portable terminal 10 is described by using a flowchart in FIG. 7.

First, when personal identification processing is started after a predetermined application is activated in response to a user operation and the like, a camera function of the portable terminal 10 is turned on. Then, the portable terminal 10 collects light by using a camera lens C on the same surface as the touch panel display 14, and generates an image.

Then, the acquisition unit 11 acquires the image generated by the camera function of the portable terminal 10 (S20).

Next, the portable terminal 10 extracts a face 1 of a user from the image (S21). When the face 1 of the user is not extracted from the image (No in S21) and a state in which the face 1 of the user is not extracted continues for a predetermined time or longer (Yes in S22), the voice guidance unit 16 outputs voice guidance for photographing the face 1 (S23). The voice guidance is, for example, “please photograph your face”, and the like, however, assuming a visually impaired user, the voice guidance may be “please turn over the portable terminal 10”, and the like. Note that, even when the face 1 of the user is not extracted from the image (No in S21), the voice guidance is not performed when the state in which the face 1 of the user is not extracted does not continue for the predetermined time or longer (No in S22).

Meanwhile, when the face 1 of the user is extracted from the image (Yes in S21), the portable terminal 10 judges whether a position of the extracted face 1 and a position of a frame F1 (see FIG. 1) superimposed on the image and displayed on the touch panel display 14 are misaligned (S24). A method of judging misalignment is a design matter. For example, when a part of the face 1 is outside the frame F1, it may be judged to be misaligned. Otherwise, when a distance between a center of the face 1 and a center of the frame F1 is equal to or more than a threshold value, it may be judged to be misaligned.

When it is judged that the position of the face 1 and the position of the frame F1 are misaligned (Yes in S24) and a state in which the misalignment is present continues for a predetermined time or longer (Yes in S25), the voice guidance unit 16 outputs voice guidance that eliminates the misalignment (S26). For example, the voice guidance unit 16 may compute in which direction the position of the face 1 is misaligned with respect to the position of the frame F1, and output voice guidance (e.g., “please move your face to a right direction”) for moving the position of the face 1 in a direction of eliminating the misalignment. Note that, when the face 1 is not misaligned with respect to the frame F1 (No in S24), the voice guidance is not performed. Further, even when the face 1 is misaligned with respect to the frame F1 (Yes in S24), the voice guidance is not performed when the state in which the face 1 is misaligned with respect to the frame F1 does not continue for the predetermined time or longer (No in S25).

Further, the portable terminal 10 extracts a personal identification document 2 from the image (S27). When the personal identification document 2 is not extracted from the image (No in S27) and a state in which the personal identification document 2 is not extracted continues for a predetermined time or longer (Yes in S28), the voice guidance unit 16 outputs voice guidance for photographing the personal identification document 2 (S29). The voice guidance is, for example, “please photograph the personal identification document 2”, and the like. Note that, even when the personal identification document 2 is not extracted from the image (No in S27), the voice guidance is not performed when the state in which the personal identification document 2 is not extracted does not continue for the predetermined time or longer (No in S28).

Meanwhile, when the personal identification document 2 is extracted from the user image (Yes in S27), the portable terminal 10 judges whether a position of the personal identification document 2 and a position of a frame F2 (see FIG. 1) superimposed on the image and displayed on the touch panel display 14 are misaligned (S30). A method of judging misalignment is a design matter. For example, when a part of the personal identification document 2 is outside the frame 2, it may be judged to be misaligned. Otherwise, when a distance between a center of the personal identification document 2 and a center of the frame F2 is equal to or more than a threshold value, it may be judged to be misaligned.

When it is judged that the position of the personal identification document 2 and the position of the frame F2 are misaligned (Yes in S30) and a state in which the misalignment is present continues for a predetermined time or longer (Yes in S31), the voice guidance unit 16 outputs voice guidance that eliminates the misalignment (S32). For example, the voice guidance unit 16 may compute in which direction the position of the personal identification document 2 is misaligned with respect to the position of the frame F2, and output voice guidance (e.g., “please move the personal identification document 2 to a right direction”) for moving the position of the personal identification document 2 in a direction of eliminating the misalignment. Note that, when the personal identification document 2 is not misaligned with respect to the frame F2 (No in S30), the voice guidance is not performed. Further, even when the personal identification document 2 is misaligned with respect to the frame F2 (Yes in S30), the voice guidance is not performed when the state in which the personal identification document 2 is misaligned with respect to the frame F2 does not continue for the predetermined time or longer (No in S31).

Other configurations of the portable terminal 10 are similar to those in the first to fourth example embodiments.

According to the portable terminal 10 according to the present example embodiment, an advantageous effect similar to that of the first to fourth example embodiments is achieved.

Further, according to the portable terminal 10 according to the present example embodiment, it is possible to detect misalignment of the face 1 and frame F1, and misalignment of the personal identification document 2 and the frame F2 by using an image analysis, and output voice guidance that eliminates the misalignment. According to the portable terminal 10, operation by a visually impaired user is also facilitated.

### Sixth Example Embodiment

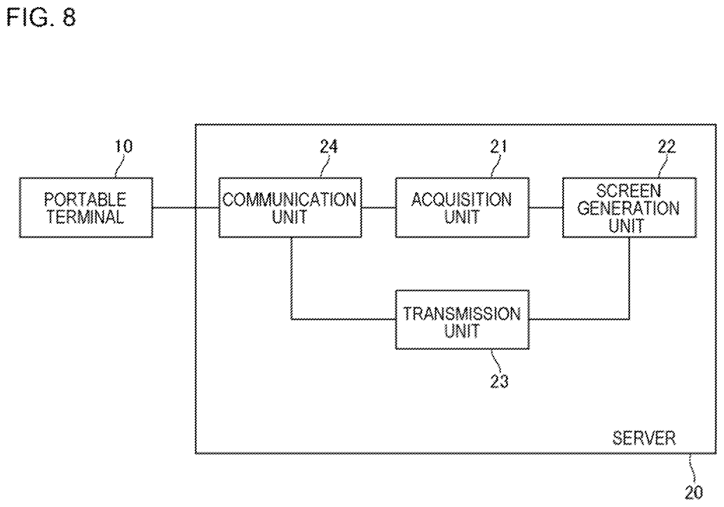

FIG. 8 illustrates a functional block diagram of a portable terminal 10 and a server 20 according to the present example embodiment. As illustrated, the server 20 includes an acquisition unit 21, a screen generation unit 22, a transmission unit 23, and a communication unit 24.

In the first to fifth example embodiments, the portable terminal 10 performs screen generation processing as illustrated in the flowchart in FIG. 4, and processing for personal identification based on a user image (collation of a face 1 of a user extracted from a user image with a face of a user extracted from a personal identification document 2) and for biometric detection.

In the present example embodiment, the portable terminal 10 transmits a user image generated by a camera function provided to the own terminal to the server 20. Further, the server 20 performs screen generation processing as illustrated in the flowchart in FIG. 4, and processing for personal identification based on the user image (collation of the face 1 of the user extracted from the user image with the face of the user extracted from the personal identification document 2) and for biometric detection. Further, the portable terminal 10 displays a screen received from the server 20 on a touch panel display 14.

The acquisition unit 21 of the server 20 has a function similar to that of the above-described acquisition unit 11. The screen generation unit 22 of the server 20 has a function similar to that of the above-described screen generation unit 12. The communication unit 24 communicates with the portable terminal 10 via a communication network such as the Internet. The acquisition unit 11 acquires, via the communication unit 24, a user image including a user generated by the portable terminal 10. The transmission unit 23 transmits, via the communication unit 24, a screen generated by the screen generation unit 12 to the portable terminal 10.

Note that, although it is not illustrated, the server 20 may include a voice guidance unit 25 having a function similar to that of the above-described voice guidance unit 16. The voice guidance unit 25 transmits, via the communication unit 24, voice guidance to the portable terminal 10.

According to the server 20 according to the present example embodiment, an advantageous effect similar to that of the portable terminal 10 according to the first to fifth example embodiments is achieved.

### Seventh Example Embodiment

In the first to fifth example embodiments, an acquisition unit 11, a screen generation unit 12, an output unit 13, an input reception unit 15, and the like are achieved on a portable terminal 10 by installing, on the portable terminal 10, an application being provided by a business entity providing a predetermined service. Then, at a time of executing personal identification processing executed based on the application, whether a hand is included in a user image including a user and whether the hand is a right hand or a left hand are judged, and a position of an operation button B is optimized according to a result of the judgement.

A portable terminal 10 according to the present example embodiment achieves an acquisition unit 11, a screen generation unit 12, an output unit 13, an input reception unit 15, and the like on the portable terminal 10 by a camera application being installed in advance on the portable terminal 10 from a stage of shipping the portable terminal 10. Further, when activating the camera application and self-photographing, whether a hand is included in a user image including a user and whether the hand is a right hand or a left hand are judged, and a position of an operation button B is optimized according to a result of the judgement. The operation button B in this case may be, for example, an operation button for executing saving of a still image, or an operation button for executing starting and ending of photographing a moving image.

According to the portable terminal 10 according to the present example embodiment, an advantageous effect similar to that of the first to fifth example embodiments is achieved.

While the invention of the present application has been described with reference to the example embodiments (and practical examples), the invention of the present application is not limited to the above-described example embodiments (and practical examples). It will be understood by those skilled in the art that various changes in form and details may be made in the invention of the present application without departing from the scope of the invention of the present application.

A part or the whole of the above-described example embodiments may be described as the following supplementary notes, but is not limited thereto.

1. A program used in a portable terminal, causing the portable terminal to function as:

an acquisition means for acquiring a user image including a user; and

a screen generation means for changing a position of an operation button on a screen to be displayed on a touch panel display, according to whether a hand of the user included in the user image is a right hand or a left hand.

2. The program according to supplementary note 1, wherein

the acquisition means acquires the user image generated by a camera function of the portable terminal, and

the screen generation means generates the screen in which the operation button is superimposed on the user image, and changes a position of the operation button on the screen according to whether a hand included in the user image is a right hand or a left hand.

3. The program according to supplementary note 2, wherein,

when a right hand is included in the user image, the screen generation means moves a position of the operation button leftward, compared to a case in which a left hand is included in the user image.

4. The program according to any one of supplementary notes 1 to 3, wherein

the screen generation means generates the screen in which frames guiding a position of a face and a position of a personal identification document are superimposed on the user image, and

the acquisition means acquires the user image including the user holding the personal identification document with one hand.

5. The program according to supplementary note 4, wherein

the screen generation means judges whether a hand of the user being included in the user image and holding the personal identification document is a right hand or a left hand, based on whether a right side or a left side of the personal identification document is held.

6. The program according to supplementary notes 4 to 5, further causing the portable terminal to function as

a voice guidance means for outputting voice guidance that eliminates misalignments of positions of a face of the user and the personal identification document detected from the user image, and positions of the frames.

7. The program according to any one of supplementary notes 1 to 6, wherein,

when a vertical length of the screen is assumed to be L, the screen generation means displays, on the screen, the operation button having a length of L/2 or longer.

8. The program according to any one of supplementary notes 1 to 7, wherein

the screen generation means changes a position of the operation button on the screen according to a size of the touch panel display.

9. A processing method for a portable terminal, including:

acquiring a user image including a user; and

changing a position of an operation button on a screen to be displayed on a touch panel display, according to whether a hand of the user included in the user image is a right hand or a left hand.

10. A portable terminal including:

an acquisition means for acquiring a user image including a user; and

a screen generation means for changing a position of an operation button on a screen to be displayed on a touch panel display, according to whether a hand of the user included in the user image is a right hand or a left hand.

11. A server including:

an acquisition means for acquiring, from a portable terminal, a user image including a user;

a screen generation means for changing a position of an operation button on a screen to be displayed on a touch panel display of the portable terminal according to whether a hand of the user included in the user image is a right hand or a left hand; and

a transmission means for transmitting the screen to the portable terminal.

This application is based upon and claims the benefit of priority form Japanese patent application No. 2020-020379 filed on Feb. 10, 2020, the disclosure of which is incorporated herein in its entirety by reference.

### REFERENCE SIGNS LIST

1A Processor
2A Memory
3A Input/output I/F
4A Peripheral circuit
5A Bus
10 Portable terminal
11 Acquisition unit
12 Screen generation unit
13 Output unit
14 Touch panel display
15 Input reception unit
16 Voice guidance unit
20 Server
21 Acquisition unit
22 Screen generation unit
23 Transmission unit
24 Communication unit
25 Voice guidance unit
1 Face
2 Personal identification document

What is claimed is:

1. A non-transitory storage medium storing a program used in a portable terminal, the program causing the portable terminal to:
acquire a user image including a user; and
change a position of an operation button on a screen to be displayed on a touch panel display, according to whether a hand of the user included in the user image is a right hand or a left hand.

2. The non-transitory storage medium according to claim 1, wherein the program causes the portable terminal to:
acquire the user image generated by a camera function of the portable terminal, and
generate the screen in which the operation button is superimposed on the user image, and change a position of the operation button on the screen according to whether a hand included in the user image is a right hand or a left hand.

3. The non-transitory storage medium according to claim 2, wherein the program causes the portable terminal to move, when a right hand is included in the user image, a position of the operation button leftward, compared to a case in which a left hand is included in the user image.

4. The non-transitory storage medium according to claim 1, wherein the program causes the portable terminal to:
generate the screen in which frames guiding a position of a face and a position of a personal identification document are superimposed on the user image, and
acquire the user image including the user holding the personal identification document with one hand.

5. The non-transitory storage medium according to claim 4, wherein the program causes the portable terminal to judge whether a hand of the user being included in the user image and holding the personal identification document is a right hand or a left hand, based on whether a right side or a left side of the personal identification document is held.

6. The non-transitory storage medium according to claim 4, further causing the portable terminal to output voice guidance that eliminates misalignments of positions of a face of the user and the personal identification document detected from the user image, and positions of the frames.

7. The non-transitory storage medium according to claim 1, wherein the program causes the portable terminal to display, when a vertical length of the screen is assumed to be L, on the screen, the operation button having a length of L/2 or longer.

8. The non-transitory storage medium program according to claim 1, wherein the program causes the portable terminal to change a position of the operation button on the screen according to a size of the touch panel display.

9. A processing method for a portable terminal, comprising:
acquiring a user image including a user; and
changing a position of an operation button on a screen to be displayed on a touch panel display, according to whether a hand of the user included in the user image is a right hand or a left hand.

10. A portable terminal comprising:
at least one memory configured to store one or more instructions; and
at least one processor configured to execute the one or more instructions to:
acquire a user image including a user; and
change a position of an operation button on a screen to be displayed on a touch panel display, according to whether a hand of the user included in the user image is a right hand or a left hand.

11. A server comprising:
at least one memory configured to store one or more instructions; and
at least one processor configured to execute the one or more instructions to:
acquire, from a portable terminal, a user image including a user;
change a position of an operation button on a screen to be displayed on a touch panel display of the portable terminal, according to whether a hand of the user included in the user image is a right hand or a left hand; and
transmit the screen to the portable terminal.
